(19) United States
(12) Patent Application Publication
(10) Pub. No.: US 2012/0102864 A1
(43) Pub. Date: May 3, 2012

(54) METHOD FOR PRODUCING WINDOW OR DOOR ELEMENTS

(75) Inventors: Bernd Eisenbach, Brechen (DE); Peter Zimmer, Grenderich (DE)

(73) Assignee: ROTOX BESITZ - UND VERWALTUNGSGESELLSCHAFT MGH, Brechen (DE)

(21) Appl. No.: 13/381,988

(22) PCT Filed: Jul. 6, 2010
(86) PCT No.: PCT/EP2010/004118

§ 371 Date: Jan. 3, 2012

(30) Foreign Application Priority Data
Jul. 13, 2009 (DE) 10 2009 033 139.5

(51) Int. Cl. E06B 3/56; E06B 3/96; B32B 37/16; E06B 3/58; B32B 37/12; B23P 11/00

(52) U.S. Cl. 52/455; 156/297; 29/469

(57) ABSTRACT

The invention relates to a method for producing window or door elements that have a profile frame made up of profile pieces, and that have at least one glass pane attached thereto. The profile pieces are pre-affixed to each other in order to form corner joints, and subsequently, the at least one glass pane is glued to the pre-affixed profile frame, so that the corner joints attain their stability from the glued-in glass pane.

### CROSS-REFERENCE TO RELATED APPLICATIONS

This application is a national stage application (under 35 U.S.C. §371) of PCT/EP2010/004118, filed Jul. 6, 2010, which claims benefit of German application 10 2009 033 139.5, filed Jul. 13, 2009.

### TECHNICAL FIELD AND STATE OF THE ART

The present invention relates to a method for producing window or door elements, comprising a profile frame made up of profile pieces, and comprising at least one glass pane attached thereto.

The invention also relates to a window or door element comprising a profile frame made up of profile sections that have been pre-affixed to each other.

Window or door elements of the type installed in buildings consist of a frame which is permanently anchored to the building structure and into which a window sash or door leaf is incorporated that comprises a frame with a glass pane inserted into it.

When the method described here refers to the production of a door leaf, then this refers to the kind that comprises a panel made up of a glass pane. Modern window or door elements are usually made of plastic profiles, aluminum profiles or wood profiles. However, it is also common practice to use frame constructions that, for insulation reasons, consist of a composite structure with an outer frame and an inner frame that are made of different materials, for example, plastic on the one hand and aluminum on the other hand.

The frame constructions usually consist of four profile pieces that—if they are profile pieces made of plastic or PVC or else aluminum—are mitered at their ends and are joined to each other along the mitered edges so firmly that the frame construction achieves the final stability that is needed for its use. Subsequently, the glass pane is placed into the frame and its edge area is covered with a covering frame.

When it comes to welded corner joints of plastic profiles, strength values of 35 N/mm², also referred to as corner strength values or ultimate strength values, are prescribed. These values are documented in Guideline DVS 2207—Part 25, issued by the German Welding Society.

In the case of window or door elements made of welded plastic profiles, the profile pieces are joined to each other by partially melting the material. Here, the melting time of the profile sections, brought about by contacting the ends of the profile sections with so-called heating mirrors or heating plates, is about 30 seconds (±15%) on average, depending on the profile that is being processed. The upset time, that is to say, the time during which the heated, “tacky” or still-softened ends of the profile section can be joined to each other, is likewise about 30 seconds (±15%) on average, depending on the profile that is being processed.

In order to join the profile pieces, material of the profile pieces is consumed at the joining site, and this is referred to as so-called melting loss. This melting loss is about 3 mm at the end of each profile section, that is to say, about 6 mm per profile section, which has to be taken into account in the form of the so-called fusing addition, when the profile section is cut.

As a rule, corner joints of aluminum profiles are produced nowadays by means of so-called corner joining machines. Here, first of all, a so-called corner angle is created in the two profile sections that are to be joined to each other. Then a hydraulically operated machine uses punching tools to remove a small part of the circumferential surface of the two aluminum profile sections near the corner on three edges of the circumferential surface, and this small part is pressed into the corner angle. In order to seal the profile sections that have been thus joined with a positive fit, a special adhesive or else silicone is injected into the area of the corner angle or of the mitered joint of the window or door element. This process of injecting sealing elements is usually carried out manually. However, there are also so-called corner joining machines that automatically inject the adhesive.

The stability of the thus-produced profile frames made of aluminum profiles is attained immediately so that the profile frames can be further processed and installed in buildings.

As a rule, in the case of window or door elements made of wood profiles, the corner joints are produced with a positive fit in that the ends of the profile section have a mortise and tenon joint. Before being joined together, the ends of the profile section that have a mortise and tenon joint are covered with an adhesive that hardens quickly, that gives the profile frame its final stability for the further processing and installation in buildings, and that, at the same time, seals the joining site.

Moreover, a window element is known in which the profile cross section of the profile frame is modified in such a way that the glass holding strips are integrated into the actual profile and do not have to be mounted separately afterwards. As a result, the work step of mounting the glass holding strips can be dispensed with. With these window frames, the glass pane is placed into the profile sections immediately before the welding procedure of the plastic profile pieces and after the application of the adhesive. During the welding procedure, the profile sections, which are still loose, can be moved in the direction of the glass pane in order to join the sections.

Various publications from the state of the art describe different types of door leaves and window sashes, their production, and the joining of the frame profile parts.

German patent application DE 39 06 278 A1 describes, for example, a method and a device for joining mitered profile parts. A joining film is inserted on the cut surfaces of the profile parts before they are joined. These joining sites account for a firm and thus durable joining of the profile parts, so that the frame made of the profile parts achieves a high final strength.

European patent application EP 1 070 824 A2 describes a window sash, especially for a plastic frame, that provides for a special seal between the glass pane and the profile which does not involve any sealing lips being inserted into the profile, but rather, the glass pane is sealed against the frame with a sealing compound. This sealing compound is also referred to as an adhesive compound.

German patent application DE 195 32 117 A1 discloses a profile frame that is made in a first step by gluing or welding the corner joints. The frame profiles themselves are stabilized by means of the inserted glass pane.

German utility model DE 20 2005 009 450 U1 likewise discloses a window or door element whose frame profile is stiffened by the glass pane after the assembly step.

The aim of the known methods, as described above, is for the corner joints of the profile frames—without the glass pane—to already achieve their final stability that corresponds to the stability that is required once the window or door frame has been installed. This calls for complex joining techniques with long cycle times for the production of the frame and involves high associated costs.

### SUMMARY OF THE INVENTION

The present invention is based on the objective of creating a method for producing window or door elements that permits an inexpensive and quick manufacture of these elements, without having a detrimental effect on the requirements of the elements once they have been installed.

This objective is achieved by a method with the above-mentioned features, which is characterized in that the profile pieces are pre-affixed to each other in order to form corner joints, and in that subsequently, the at least one glass pane is glued to the pre-affixed profile frame, so that the corner joints acquire their stability from the glued-in glass pane.

It is also the objective of the present invention to put forward a window or door element with a profile frame made of profile sections that—without any loss in stability—can be produced more quickly and inexpensively.

Since the profile pieces of the profile frame are only pre-affixed to each other in such a way that the corner joints of the profile frame first have sufficient stability to allow the profile frame to be handled for purposes of further processing and mounting work, the production effort and the cycle time for the production of the frames is considerably reduced, with corresponding cost savings. The final stability of the window or door element is only achieved once the glass pane has been glued into the profile frame.

Thus, the method according to the invention entails considerable advantages in comparison to the methods according to the state of the art.

On the basis of the method according to the invention, it can especially be provided in an advantageous manner that the pre-affixed corner joints attain the stability required for a window or door element from the glued-in glass pane. In particular, as an alternative or in addition, it can be provided that the corner joints attain at least the same stability as conventional corner joints from the glued-in glass pane, namely, a strength of at least 35 N/mm², without a stabilizing glass pane. This is the strength required by Guideline DVS 2207—Part 25, issued by the German Welding Society, for the corner joints of finished window and door elements.

Accordingly, in an advantageous manner that cuts down on the production work, it can be provided that the pre-affixed corner joints alone—without the glued-in glass pane—have a stability that is lower than the stability required for a window or door element, and it can especially be provided that the pre-affixed corner joints have a strength of less than 35 N/mm².

When profile frames made of welded plastic profile pieces are produced, the actual welding time that results from the melting time and the upset time can be reduced by at least 30% in comparison to conventional methods. With certain types of profiles, the time savings can amount to 50% or more.

As explained above, the length of the profile sections or of the welding blanks is normally reduced during the welding of plastic profile pieces. For this reason, the cut profile sections are oversized by about 3 mm at the end of each profile section, with an eye towards the so-called melting loss. The so-called fusing addition is thus normally about 6 mm per profile section. According to the invention, this oversize of each of the two ends of the profile sections is partially melted during the welding procedure and, while they are still tacky, they are joined together during the so-called upsetting process. In other words, the length of the profile section of the finished window is reduced by the fusing addition of about 6 mm in comparison to the blanks. The method according to the invention makes it possible to reduce this oversize by at least 30%, in certain cases by even more than 50%, since the ends of the profiles only have to be melted and upset just enough for the profile frame to be sufficiently pre-affixed for the further handling. The reason is that, in the method according to the invention, the final stability is only achieved once the glass pane has been glued in place.

Since the melting loss and the required oversize of the profile sections are smaller in the production method according to the invention, no weld beads are formed, thereby simplifying the procedure of cleaning the corners, which is carried out after the welding procedure. At the very least, smaller weld beads translate into faster advance rates during the burr-removal and cleaning procedures. In certain cases, the cleaning of certain places of the welded corners can even be completely dispensed with.

As far as the production of profile frames made of aluminum profiles is concerned, the method according to the invention has the advantage that the corner joints of the aluminum profiles no longer have to be produced with a positive fit by means of corner joining machines. According to the method, the corner joints of the profile frame are only pre-affixed, for example, tacked, for which purpose it is possible to use, for instance, pins, screws or rivets that are inserted perpendicular to the corner joint, also, for example, without using machines. In this case as well, the window or door frame attains the necessary stability for its installation into buildings once the glass pane has been glued in.

In the case of window or door frames made of wood profiles that are produced by means of the method according to the invention, the ends of the profile sections do not have to have mortise and tenon joints, which have to be prepared with laborious milling procedures. The ends of the profile sections only have to be mitered and can be tacked and thus pre-affixed, for example, by means of pins, screws, rivets, or metal brackets that are inserted perpendicular to the miter.

Whereas the advantages of the method according to the invention have been described above with reference to types of profiles made of different materials, there are also advantages in comparison to the state of the art that are independent of the material of which the profile pieces are made.

As is known, the cross sections of the profiles, can be reduced in size in comparison to the cross sections that have been needed until now, since, up to a certain size, the glass pane gives the window frame the requisite stability in the form of the adhesive joint between the glass pane and the profile frame. Moreover, due to the narrower cross section of the profiles, a larger glass surface area is obtained, even when the outer dimensions of the frame are the same.

Another advantage of the method according to the invention can be seen in the fact that there is no longer a need for glass holding strips. As a rule, such glass holding strips are normally installed after the glass pane has been mounted, that is to say, towards the end of the production process of the window or door element, and they secure the glass pane in the frame. Consequently, the frame has the task of holding the glass pane and therefore has to be sufficiently dimensionally stable, especially at the corner joints. As a result, the frame is severely stressed by the glass pane that has been inserted into the frame and that is only held by the glass holding strips, especially since the glass pane accounts for most of the weight of the window or door element. In contrast to this, in the method according to the invention, the glass pane that has been glued into the profile frame stabilizes the profile frame and thus the entire window or door element.

Preferably, pre-affixing the profile pieces of the profile frame is carried out in such a way that the profile sections are joined so as to be essentially liquid-tight. Consequently, no more subsequent method steps are needed to seal the joint sites between the individual profile sections.

The profile pieces can be pre-affixed by welding or gluing, especially as a function of the material being used for the profile sections.

The profile frame and the glass pane are held in a fixed position for such a reaction time of the adhesive that the assembly consisting of the profile frame and the glass pane achieves sufficient stability to allow it to be handled. The final strength of the joint or the hardening of the adhesive can then be reached during the further handling or storage of the window or door element.

If the profile frame is made of plastic profiles that are welded together, polyvinyl chloride or polypropylene hollow profiles are preferably used.

As was already described above, the method according to the invention is not only suitable for profile frames made of plastic, but rather, also for those made of metal hollow profiles, especially aluminum hollow profiles or wood profiles.

One-component or two-component adhesives have proven to be well-suited for affixing the glass pane in pre-affixed process frames. Suitable one-component adhesives include melt adhesives, especially hot-melt adhesives, that is to say, thermoplastic adhesives, based on polymers that normally soften at a temperature between 80° C. and 220° C. [176° F. and 428° F.], and that harden again when they cool off. Other one-component adhesives are adhesives that belong to the group of hot-melt adhesives. Suitable two-component adhesives are those based on silicon or polyurethane.

### DETAILED DESCRIPTION OF AN EMBODIMENT

Additional objectives, advantages, features and application possibilities of the present invention can be gleaned from the description below of an embodiment with reference to a flow diagram depicted herein that illustrates the individual process steps.

On the basis of this flow diagram, it becomes clear that the pre-affixed profile frame has a stability that is sufficient for further handling during the manufacturing sequence, but that is not adequate for the installation of the frame for its final use. This final stability is only achieved with the glass pane that has a high intrinsic stability and that is glued into the pre-affixed frame. Thus, this method takes the approach that the actual stability of the window or door element is achieved with the glass pane itself, and not with the intrinsic stability of the frame that stems from the joining sites of the individual profile pieces.

When it comes to the pre-affixed corner joints of the profile pieces or sections, strength values of about 7 to 20 N/mm² are sufficient to affix them, whereby the strength values also depend on the size and weight of the frame.

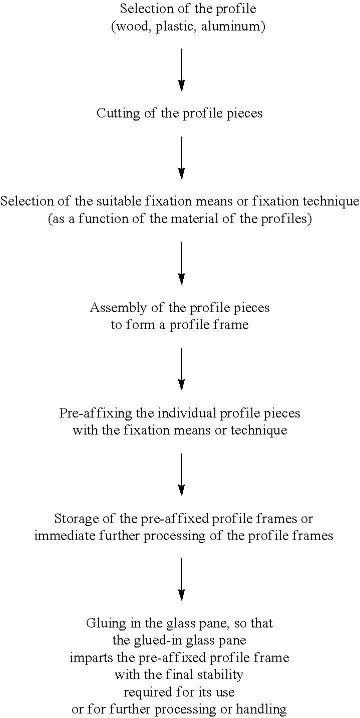

While preferred embodiments of the invention have been described and illustrated here, various changes, substitutions and modifications to the described embodiments will become apparent to those of ordinary skill in the art without thereby departing from the scope and spirit of the invention.

1. (canceled)

2. The method according to claim 16, characterized in that, due to the glued-in glass pane, the corner joints have the stability needed for a window or door element and/or at least the same stability as conventional corner joints at a strength of at least 35 N/mm², without a stabilizing glass pane.

3. The method according to claim 16, characterized in that at least one of the corner joints—without the glued-in glass pane—has a stability that is lower than the stability required for a window or door element, and/or in that the corner joints have a strength of less than 35 N/mm².

4. The method according to claim 16, characterized in that the affixing is carried out in such a way that the profile sections are joined so as to be essentially liquid-tight.

5. The method according to claim 16, characterized in that the profile pieces are affixed by welding.

6. The method according to claim 5, characterized in that the profile sections each have a fusing addition that is less than 6 mm.

7. The method according to claim 16, characterized in that the profile pieces are affixed by gluing.

8. The method according to claim 7, characterized in that the profile frame and the glass pane are held in a fixed position for such a reaction time of the adhesive that the window or door element composed of the profile frame and the glass pane achieves sufficient stability to be handled.

9. The method according to claim 16, characterized in that the profile pieces are selected from the group consisting of: weldable plastic profiles, polyvinyl chloride profiles, hollow profiles, hollow profiles made of metal, hollow profiles made of aluminum, and wood profiles.

10. The method according to claim 16, characterized in that a hot-melt adhesive is used as the adhesive.

11. A window or door element produced according to the method of claim 16.

12. A window or door element comprising a profile frame made up of profile sections that have been pre-affixed to each other and to which a glued-in glass pane has been joined, whereby the pre-affixing has created corner joints that attain the stability required for a window or door element from the glued-in glass pane, or the corner joints attain at least the same stability as conventional corner joints from the glued-in glass pane, namely, a strength of at least 35 N/mm², without a stabilizing glass pane.

13. (canceled)

14. The window or door element according to claim 12, characterized in that the corner joints are produced by welding the profile sections.

15. The window or door element according to claim 14, characterized in that the profile frame is made up of profile sections that, before the welding, each have a fusing addition that is less than 6 mm.

16. A method for making a window or door element, comprising:
affixing two or more profile pieces to each other to form an individual corner joint of a profile frame;
forming the profile frame from multiple corner joints of affixed profile pieces; and
subsequently gluing with adhesive at least one glass pane to the profile frame to form the window or door element so that the corner joints attain stability from the glued-in glass pane.

17. The method of claim 16, wherein the adhesive is a hot melt adhesive selected from the group consisting of: polyurethane based adhesives and polyolefin based adhesives.

18. A method for shortening production cycle time for making a window or door element, comprising:
pre-affixing two or more profile pieces to each other to form an individual corner joint of a profile frame;
forming the profile frame from multiple corner joints of pre-affixed profile pieces; and
joining a window pane to the profile frame to form the window or door element.

19. The method of claim 18, wherein the profile pieces are comprised of plastic and are pre-affixed to each other by welding.

20. The method of claim 19, wherein the profile pieces comprise a fusing addition that is in the range of about 1.5 mm to about 4.5 mm.

21. The method of claim 18, wherein the profile pieces are comprised of wood and pre-affixing is without use of mortise and tenon joints.

22. The method of claim 18, wherein the profile pieces are comprised of aluminum or other metal and pre-affixing is by tacking with one or more fasteners.
